(19) United States
(12) Patent Application Publication
(10) Pub. No.: US 2015/0082043 A1
(43) Pub. Date: Mar. 19, 2015

(54) TERMINAL, SERVER AND DIGITAL CONTENT AUTHORIZATION METHOD

(71) Applicants: Peking University Founder Group Co., Ltd., Beijing (CN); Founder Information Industry Group, Beijing (CN); Founder Apabi Technology Limited, Beijing (CN)

(72) Inventors: Haitao WANG, Beijing (CN); Li DING, Beijing (CN); Yun LI, Beijing (CN); Jiayin CAO, Beijing (CN)

(73) Assignees: Peking University Founder Group Co., Ltd., Beijing (CN); Founder Information Industry Group, Beijing (CN); Founder Apabi Technology Limited, Beijing (CN)

(21) Appl. No.: 14/095,566

(22) Filed: Dec. 3, 2013

(30) Foreign Application Priority Data
Sep. 13, 2013 (CN) 201310416849.2

(51) Int. Cl. H04L 29/06

(52) U.S. Cl. CPC H04L 63/0471
USPC 713/175

(57) ABSTRACT

The present application provides a terminal, a server and a digital content authorization method. The terminal comprises: an extracting unit, configured to extract identification information of the terminal when the terminal requests an authorization for a designated layer of content of digital contents from a server; a transceiver unit, configured to transmit the identification information of the terminal to the server and receive an authorization certificate and the designated layer of content of the digital contents from the server; and a decryption unit, configured to decrypt the designated layer of content of the digital contents based on the identification information and the authorization certificate. Embodiments of the present invention may support the copyright protection by using layered encryption technique. The digital content cannot be read only by copying so as to enhance the protection of the digital contents.

### CROSS-REFERENCE TO RELATED APPLICATIONS

The present application claims priority to Chinese Patent Application No. 201310416849.2 filed before the Chinese Patent Office on Sep. 13, 2013 and entitled “TERMINAL, SERVER AND DIGITAL CONTENT AUTHORIZATION METHOD”, which is incorporated herein by reference in its entirety.

### TECHNICAL FIELD

The present application relates to the field of computer technology, in particular to a terminal, a server and a digital content authorization method.

### BACKGROUND

Along with the development of network technologies and digital publication technologies and versatile applications of various digital content products, it is desirable for a user that the same logic page of a digital content product contains more contents and layers. Meanwhile, it is desirable for a content provider to control different layers in the same logic page of the digital content products so as to gain the maximum profit. For example, in the condition of producing a test paper, the test paper normally only contains questions. People can obtain this test paper by various ways and open it to answer questions. The test paper further contains a layer of answers. The questions and the answers may be shown in the same page after authorization. In this circumstance, contents in one page of the digital content product are logically divided into several units, each unit is a layer. The user may purchase different layers of a book once or for several times for reading the contents. For the contents in the layer purchased each time, the content provider needs to provide an authorization corresponding to this purchase. In order to meet user's requirements for the different layers of the digital content product, a layered encryption method is provided and an authorization control is implemented to the layered contents.

Currently, there are solutions for a file containing several layers, but these solutions do not contain contents under the copyright protection. There are also some copyright protection solutions. One type of solution is to encrypt all layers in a file with a same key by a same encryption method. A server provides authorization according to the requirements of the user. A client obtains the authorization and analyzes it so as to obtain the key and contents of the layers of the file and displays the contents on an interface. In this method, one key is applied to all layers of the digital contents so that security cannot be guaranteed. All contents may be obtained by a person after decryption. Furthermore, all controls are implemented in the client so that the contents are prone to leak. The above mentioned solutions cannot meet the requirements of copyright protection control and the application requirements of the publisher to digital content products and cannot guarantee the legal right of the publisher. Another type of solution is to use a plurality of keys to encrypt a plurality of layers respectively, the sever issues a unified certification to clients for reading. Under this circumstance, after getting the certification and the encrypted file, a client may copy them to other clients for reading. Therefore, it cannot be guaranteed that the contents are only provided to the authorized user and the contents are prone to leak and the right of publisher is damaged.

Therefore, there is a problem to be solved that how to design a solution which support layered encryption for enhanced copyright protection and contents cannot be read only by copy.

### SUMMARY

Based on the above background, the technical problem to be solved by the present invention is to provide a data content authorization technique which supports a layered encryption for copyright protection. With this technique, digital contents cannot be read only by copy so as to enhance the protection of the digital contents.

In an aspect of the present invention, a terminal comprises: an extracting unit, configured to extract identification information of the terminal when the terminal requests an authorization for a designated layer of content of digital contents from a server; a transceiver unit, configured to transmit the identification information of the terminal to the server and receive an authorization certificate and the designated layer of content of the digital contents from the server; and a decryption unit, configured to decrypt the designated layer of content of the digital contents based on the identification information and the authorization certificate.

In this aspect, the designated layer of content of the digital contents is bonded with the identification information of the terminal so that even if the designated layer of content of the digital contents and the authorization certificate are copied from the terminal to other terminals, the content cannot be decrypted. Therefore, the digital contents cannot be randomly spread, the layered authorization can be applied to the digital contents and security protection is improved.

In another aspect of the present invention, a server comprises: a communication unit, configured to receive identification information and an authorization request for a designated layer of content of digital contents from a terminal, and transmit the designated layer of content of the digital contents and an authorization certificate to the terminal; and an encryption unit, configured to generate the authorization certificate based on the identification information and a key of the designated layer of content of the digital contents.

After receiving the authorization request, the server generates the authorization certificate of the designated layer of content of the digital contents based on the identification information of the terminal, so that the digital contents can only be decrypted base on the identification information of the terminal. Therefore, the digital contents cannot be randomly spread.

In further another aspect of the present invention, a digital content authorization method comprises: by a terminal, when the terminal requests authorization for a designated layer of content of digital contents from a server, sending identification information of the terminal to the server; and obtaining a key of the designated layer of content of the digital contents based on the identification information and the authorization certificate from the server, so as to decrypt the designated layer of content of the digital contents.

In this aspect, the designated layer of content of the digital contents is bonded with the identification information of the terminal so that even if the designated layer of content of the digital contents and the authorization certificate are copied from the terminal to other terminals, the content cannot be decrypted. Therefore, the digital contents cannot be randomly spread, the layered authorization can be applied to the digital contents and security protection is improved.

In yet another aspect of the present invention, a digital content authorization method comprising: by a server, receiving identification information and a authorization request for a designated layer of content of digital contents from a terminal; the server generating an authorization certificate based on the identification information and a key of the designated layer of content of the digital contents; and sending the designated layer of content of the digital contents and the authorization certificate to the terminal.

In this aspect, the designated layer of content of the digital contents is bonded with the identification information of the terminal so that even if the designated layer of content of the digital contents and the authorization certificate are copied from the terminal to other terminals, the content cannot be decrypted. Therefore, the digital contents cannot be randomly spread, the layered authorization can be applied to the digital contents and security protection is improved.

### BRIEF DESCRIPTION OF THE DRAWINGS

FIG. 1 is a block diagram showing a terminal according to an embodiment of the present invention;

FIG. 2 is a block diagram showing a server according to an embodiment of the present invention;

FIG. 3 is a schematics diagram showing a digital content layered encryption process according to an embodiment of the present invention;

FIG. 4 is a schematics diagram showing a digital content authorization processing system according to an embodiment of the present invention; and

FIG. 5 is a flow chart showing a digital content authorization method according to an embodiment of the present invention.

### DETAILED DESCRIPTION

In order to clearly understand the above objectives, features and advantages, the disclosure is described hereinafter in conjunction with the drawings as well as embodiments. It should be note that features in an embodiment or embodiments may be combined if not confliction.

The following description describes a lot details for fully understanding the present invention. However, embodiments of the present invention may be implemented by ways other than ones described herein. Therefore, the embodiments of the present invention are not limited to those disclosed hereafter.

A terminal according to embodiments of the present invention may be a cell phone, a lap top, a desk top, a digital radio receiver, a personal digital assistance, a portable multimedia player, a camera, a navigation device, a tablet PC and/or an ebook reader.

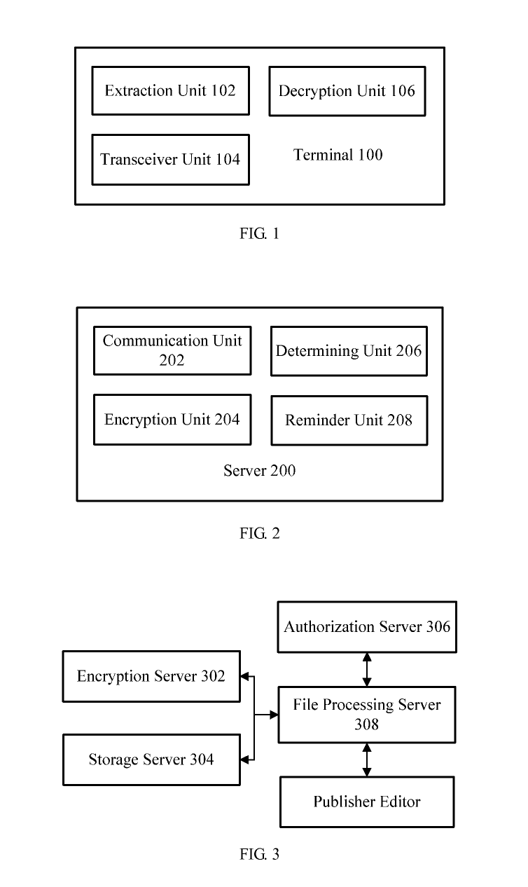

FIG. 1 is a block diagram showing a terminal according to an embodiment of the present invention. As shown in FIG. 1, in the embodiment, the terminal 100 comprises: an extracting unit 102, configured to extract identification information of the terminal 100 when the terminal requests an authorization for a designated layer of content of digital contents from a server, for example, the identification may be the hardware sequence number of a cell phone; a transceiver unit 104, configured to transmit the identification information of the terminal 100 to the server and receive an authorization certificate and the designated layer of content of the digital contents; and a decryption unit 106, configured to decrypt the designated layer of content of the digital contents according to the identification information and the authorization certificate. The transceiver unit 104 may comprise a mobile communication module and/or a short distance communication module.

By this technical solution, the designated layer of content of the digital contents is bonded with the identification information of the terminal so that even if the designated layer of content of the digital contents and the authorization certificate are copied from the terminal to other terminals, the content cannot be decrypted. Therefore, the digital contents cannot be randomly spread, the layered authorization can be applied to the digital contents and the security protection is improved.

In the above technical solution, preferably, the identification information includes a unique identifier of the terminal 100. The unique identifier may be a unique identifier of a terminal hardware or a unique identifier of a software client.

FIG. 2 is a block diagram showing a server according to an embodiment of the present invention.

As shown in FIG. 2, the server 200 according to the embodiment of the present invention comprises: a communication unit 202, configured to receive identification information and an authorization request for a designated layer of content of digital contents from a terminal, and transmit the designated layer of content of the digital contents and an authorization certificate generated by an encryption unit 204 to the terminal; and the encryption unit 204, configured to generate the authorization certificate based on the identification information and a key of the designated layer of content of the digital contents.

After receiving the authorization request, the server generates the authorization certificate for the designated layer of content of the digital contents based on the identification information of the terminal so that the terminal may decrypt the digital contents only based on the identification information of the terminal so that the digital contents cannot be randomly copied and spread.

In the above technical solution, preferably, the encryption unit 204 encrypts the key based on the identification information, and generates the authorization certificate based on the encrypted key and an identifier of the designated layer of the digital contents.

Each layer of digital content has a corresponding key. In order to accelerate the encryption process and lessen the load of the server, the key of the corresponding layer of digital content is encrypted based on the identification information of the terminal. Since the encryption process of each layer of digital content has been finished in advance, when the authorization request from the terminal is received, only the key of the corresponding layer of digital content needs to be encrypted so as to accelerate the encryption process. Therefore, during decryption, only the key of the corresponding layer of content needs to be decrypted, the key of the corresponding layer of digital content can be obtained. The corresponding layer of digital content may be read with this key. In a similar way, the authorization of other layers of digital contents may be obtained.

In the above technical solution, preferably, the server further comprises: a determining unit 206, configured to determine whether the terminal has obtained the authorization of the designated layer of content based on the identification information and the identifier of the designated layer of content; and a reminder unit 208, configured to remind to obtain authorization for other layers of contents of the digital contents when the terminal has obtained the authorization for the designated layer of content.

Since the digital contents have a plurality of layers, the user may forget which layer of digital content has been obtained. The identification information of the terminal may prevent the digital content form copying and be used to determine whether the user has been authorized for some layers of digital contents. Therefore, double authorization and unnecessary lost may be avoided. Similarly, if the user deletes the authorized corresponding layer of digital content by accident, the corresponding layer of digital content may be resent to the terminal and authorization may be implemented again based on the identification information.

The above technical solution according to the present invention solves the problem of how to encrypt a file containing a plurality of layers and how to provide copyright protection for such file. That is, the plurality of layers of the file are encrypted by different keys respectively, the server issues authorization for a corresponding layer based on the user's requirement, the client provides its own identification information, the server encrypts a key of the file according to the identification information of the client and returns the authorization certificate, the client obtains the corresponding key based on its own identification information and the authorization for the corresponding layer, and implements further application. Therefore, the application problem of the file containing a plurality of layers under the authorization protection is solved. According to the embodiment of the present invention, different content versions are provided by utilizing the characteristics that a file has a plurality of layers, the digital content product may be reasonably used by the copyright protection and authorization control method. The digital content product cannot be randomly spread under the copyright protection technique.

The process of implementing layered authorization for digital contents mainly comprises the steps as follows.

1. A file is produced as a layered file, different contents of the file (such as text, picture, audio, video, cartoon and so on) are recorded in the different layers respectively, each page of the file has a fixed number of layers with each layer having a unique identification.

2. The server generates a key for each layer. A different layer and the content thereof are encrypted by a symmetric encryption algorithm. The layer which is not sensitive or desirable to be widely used is not encrypted. The server keeps the identification of each layer and the corresponding key.

3. The client extracts its own identification information (hardware device information or software identification information) and sends the identification information to the server and requests authorization for a specific layer of the file.

4. Upon the request of the user, the server encrypts the key corresponding to the specific layer of file by the identification information of the client, and forms an authorization certificate by combining the encrypted key and the identification of the layer, and sends the authorization certificate to the client.

5. The client extracts its own identification information to analyze the authorization certificate and obtains the key of the required layer.

6. The client uses the obtained key and the identification of the layer to analyze the content in the corresponding layer.

7. The client shows the content to the user.

In the embodiment, different contents in the same digital content product are placed in different layers, and different keys are used to encrypt the contents in different layers, and the layered contents are authorized respectively. A reader may check the content in one layer and obtain the right to read the hidden contents by purchasing the authorization. The client shows the contents in corresponding layer according to the authorization from the server. When the reader purchases new authorization for contents in other layers of the same digital content product again, the server sends the authorization for the corresponding layers and the client uses such authorization to serve the reader.

The digital content layering and encryption process is described in detail with reference to FIG. 3.

When the user implements copyright protection by the layered authorization according to the present invention, firstly, a file is divided into different layers and different keys are used to respectively encrypt the different layers. Only the authorization for the required layer in the file is provided to the user from the server, existing right of the digital content product will not be damaged and different file versions will be provided to different user as required. Therefore, the copyright protection with user personality and fine granularity is implemented and the corresponding authorization and application can be timely controlled.

As shown in FIG. 3, an editor in a publisher organizes contents of a file, for example, questions and answers of a test paper are respectively organized. A file processing server 308 produces layered contents from the contents of the file, and embeds these layered contents into different layers of the file (different contents are described in different layers). Each layer of the file has a unique number, which is called a file layer unique number, and each layer of the file forms a file which has a file unique number.

The file processing server 308 sends the file unique number and all file layer unique numbers in the file to an authorization server 306 to apply for encryption keys.

The authorization server 306 generates a key for each layer of the file to be encrypted and records the keys in the authorization server 306. The keys of the corresponding file layers then are sent back to the file processing server 308.

The file processing server 308 provides the keys and the file to an encryption server 302. The encryption server 302 encrypts different file layers by using keys of the file layers. The encryption sever 302 uploads the encrypted file to a storage server 304.

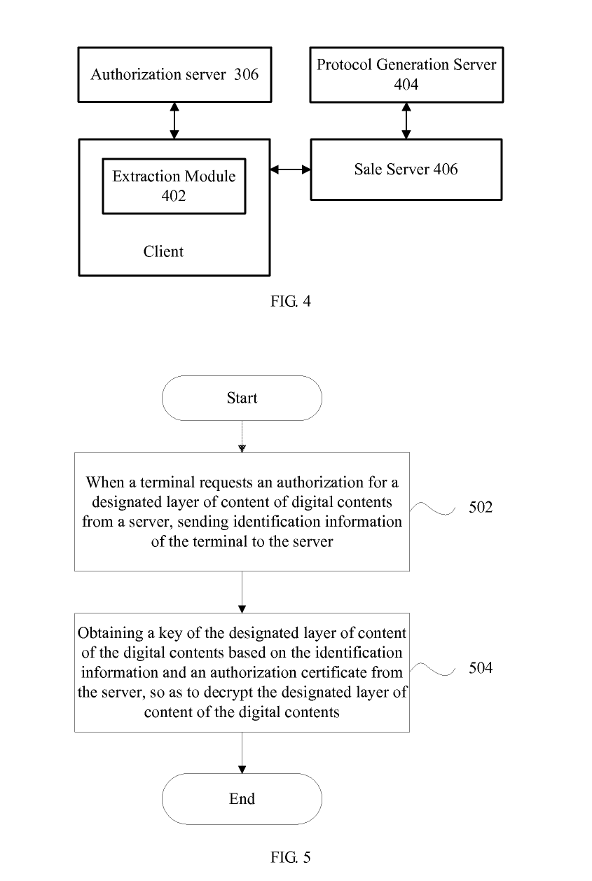

FIG. 4 is a schematics diagram showing a digital content authorization processing system according to an embodiment of the present invention.

As shown in FIG. 4, in the present embodiment, if a reader directly downloads an encrypted file from a website and the file only contains right to use one layer. If the reader has used the right for the one layer and wants rights for other layers, the reader may purchase the right for another layer from a sale server 406. The sale server 406 sends the order information, the file unique number and the file layer unique number to a protocol generation server 404. The protocol generation server 404 generates a copyright protection protocol file based on the order information, the file unique number and the file layer unique number. The copyright protection protocol file contains the order information, the file unique number and the file layer unique number, the file download address and the authorization server address. The protocol generation server 404 then sends the copyright protection protocol file back to the sale server 406. The sale server 406 sends the copyright protection protocol file to the client.

The client analyzes the copyright protection protocol file, obtains the order information, the file unique number and the file layer unique number, the file download address and the authorization server address. An extraction module 402 of the client extracts the identification information of the client (hardware information or software identification information), requests authorization from the authorization server 306 by combining the order information, the file unique number and the file layer unique layer.

The authorization server 306 verifies the request. If the request is legal, a layered authorization certificate is generated. The layered authorization certificate contains a layered key and the key is encrypted by the identification information of the client. The authorization server 306 sends the authorization certificate back to the client.

The client decrypts the encrypted file with the authorization certificate, and obtains authorized layered contents. The client uses the authorized layered right and contents.

The digital content authorization process according to the present invention is explained by a specific example.

There is a test paper named a mid-term exam for mathematics in grade one of the primary school. There are totally 20 questions Q and 20 answers A. A user downloads the test paper from a server and opens the questions for examination. Currently, only the questions are visible and answers are not visible. The user may request authorization from the server and obtain the answers so that the questions and the answers are displayed at the same time.

Firstly, the questions and the answers are respectively organized, so that the file processing server stores the questions and the answers in layer 1 and layer 2 respectively. The unique identification of layer 1 and layer 2 are set as LQ and LA. A unified file NEF is formed. A unique identification FID is set for the file NEF. The layered contents and corresponding identification are provided to the encryption server 302.

The encryption server 302 sends FID, LQ and LA to the authorization server 306 and requests an encryption key. The authorization server 306 records FID, LQ and LA, returns one key for each layer, the keys for layer LQ and layer LA are EQ and EA respectively.

The encryption server 302 encrypts the contents in the layers identified as LQ and LA by using EQ and EA and forms an encrypted file EF. The encryption server 302 uploads the encrypted file EF to the storage server 304.

The user purchases the answers of the test paper from the sale server 406 so as to obtain the right to read LA. The sale server 406 sends the order information and LA to the protocol generation server 404.

The protocol generation server 404 generates an authorization protocol based on the information uploaded by the sale server 406, and returns the authorization protocol to the sale server 406. The sale server 406 sends the generated authorization protocol to the client.

The client analyzes the authorization protocol, obtains the authorization server address. The client obtains its own identification information HID (hardware information or software identification information of the client), sends the identification information HID and the protocol content to the authorization server 306 to apply for the authorization for LA.

The authorization server 306 forms an authorization certificate SC based on the identification information of the client HID and the key for encrypting LA contents. The authorization server 306 returns the authorization certificate SC to the client.

The client decrypts the encrypted file based on the authorization certificate SC and the encrypted file EF and its own identification information HID, obtains the answers of the file and shows them to the user. Therefore, the answers and questions of one test paper may be separated, after authorization for the answers of the test paper, only the authorized client can use the answers of the test paper, so as to prevent the answers of the test paper from being randomly spread.

It should be noted that the authorization server 306 may determine whether the client has obtained the authorization for corresponding layer of contents based on the identification information of the client. If yes, the user is reminded that the corresponding layer of contents has been authorized and the authorization for other layers of contents may be pursued.

FIG. 5 is a flow chart showing a digital content authorization method according to an embodiment of the present invention.

As shown in FIG. 5, the digital content authorization method according to the embodiment of the present invention may comprise the following steps.

In step 502, when a terminal requests authorization for a designated layer of content of digital contents from a server, the terminal sends its identification information to the server. In step 504, the terminal obtains a key of the designated layer of content of the digital contents based on the identification information and an authorization certificate from the server, so as to decrypt the designated layer of content of the digital contents.

In the above technical solution, preferably, the identification information contains the unique identification number of the client.

The digital content authorization method according to another embodiment of the present invention may comprises: receiving the identification information and the authorization request for the designated layer of content of the digital contents from the terminal; generating the authorization certificate based on the identification information and the key of the designated layer of content of the digital contents; sending the designated layer of content of the digital contents and the authorization certificate to the terminal. Wherein, the process of generating the authorization certificate based on the identification information and the key of the designated layer of content of the digital contents comprises encrypting the key based on the identification information and generating the authorization certificate based on the key after encryption process and the identification of the designated layer of content of the digital contents.

In the above technical solutions, preferably, the method further comprises: by the server, determining whether the terminal has obtained the authorization for the designated layer of content based on the identification information and the identification of the designated layer of content, if the terminal has obtained the authorization of the designated layer of content, reminding the client to obtain authorization for other layers of contents of the digital contents. Since the digital contents have a plurality of layers, the user may forget which layers of digital content have been obtained. The identification information of the terminal may prevent the digital content from copying and is used to determine whether the user has been authorized for some layers of digital contents. Therefore, double authorization and unnecessary lost may be avoided. Similarly, if the user deletes the authorized corresponding layer of digital content by accident, the corresponding layer of digital content may be resent to the terminal and authorization may be implemented again based on the identification information.

The digital authorization method according to another embodiment of the present invention may comprises: by the terminal, sending the identification information of the terminal to the server when the terminal requests the authorization for a designated layer of content of digital contents from the server; by the server, encrypting the designated layer of content of the digital contents according to the identification information and sending the encrypted designated layer of content to the terminal; and by the terminal, decrypting the designated layer of content based on the identification information.

By this technical solution, the designated layer of content of the digital contents is bonded with the identification information of the terminal so that even if the designated layer of content of the digital contents and the authorization certificate are copied from the terminal to other terminals, the content cannot be decrypted. Therefore, the digital contents cannot be randomly spread, the layered authorization can be applied to the digital contents and security protection is improved.

In the above technical solutions, preferably, the method further comprises: by the server, determining whether the terminal has obtained the authorization for the designated layer of content based on the identification information, if the terminal has obtained the authorization of the designated layer of content, reminding the client to obtain the authorization for other layers of contents of the digital contents.

Since the digital contents have a plurality of layers, the user may forget which layers of digital content have been obtained. The identification information of the terminal may prevent the digital content form copying and is used to determine whether the user has been authorized for some layers of digital contents. Therefore, double authorization and unnecessary lost may be avoided. Similarly, if the user deletes the authorized corresponding layer of digital content by accident, the corresponding layer of digital content may be resent to the terminal and authorization may be implemented again based on the identification information.

The technical solution of the present invention has been described in details in conjunction with the drawings. The above technical solution according to the present invention solves the problem of how to encrypt a file containing a plurality of layers and how to provide copyright protection for such file. That is, the plurality of layers of the file are encrypted by different keys respectively, the server issues authorization for a corresponding layer based on the user's requirement, the client provides its own identification information, the server encrypts a key of the file according to the identification information of the client and returns the authorization certificate, the client obtains the corresponding key based on its own identification information and the authorization for the corresponding layer, and implements further application. Therefore, the application problem of the file containing a plurality of layers under the authorization protection is solved. According to the embodiment of the present invention, different content versions are provided by utilizing the characteristics that a file has a plurality of layers, the digital content product may be reasonably used by the copyright protection and authorization control method. The digital content product cannot be randomly spread under the copyright protection technique.

The above are merely the preferred embodiments of the present invention. It should be noted that, a person skilled in the art may make improvements and modifications without departing from the principle of the present invention, and these improvements and modifications shall also be considered as the scope of the present invention.

What is claimed is:

1. A terminal comprising:
an extracting unit, configured to extract identification information of the terminal when the terminal requests an authorization for a designated layer of content of digital contents from a server;
a transceiver unit, configured to transmit the identification information of the terminal to the server and receive an authorization certificate and the designated layer of content of the digital contents from the server; and
a decryption unit, configured to decrypt the designated layer of content of the digital contents based on the identification information and the authorization certificate.

2. The terminal according to claim 1, wherein the identification information contains a unique identification number of the terminal.

3. A server comprising:
a communication unit, configured to receive identification information and an authorization request for a designated layer of content of digital contents from a terminal, and transmit the designated layer of content of the digital contents and an authorization certificate to the terminal; and
an encryption unit, configured to generate the authorization certificate based on the identification information and a key of the designated layer of content of the digital contents.

4. The server according to claim 3, wherein the encryption unit encrypts the key based on the identification information, and generates the authorization certificate based on the encrypted key and an identifier of the designated layer of content of the digital contents.

5. The server according to claim 3, further comprising:
a determining unit, configured to determine whether the terminal has obtained the authorization of the designated layer of content based on the identification information and the identifier of the designated layer of content; and
a reminder unit, configured to remind to obtain authorization for other layers of contents of the digital contents when the terminal has obtained authorization for the designated layer of content.

6. The server according to claim 4, further comprising:
a determining unit, configured to determine whether the terminal has obtained the authorization of the designated layer of content based on the identification information and the identifier of the designated layer of content; and
a reminder unit, configured to remind to obtain authorization for other layers of contents of the digital contents when the terminal has obtained authorization for the designated layer of content.

7. A digital content authorization method comprising: by a terminal,
when the terminal requests authorization for a designated layer of content of digital contents from a server, sending identification information of the terminal to the server; and
obtaining a key of the designated layer of content of the digital contents based on the identification information and an authorization certificate from the server, so as to decrypt the designated layer of content of the digital contents.

8. The digital content authorization method according to claim 7, wherein the identification information contains a unique identification number of the terminal.

9. A digital content authorization method comprising: by a server,
receiving identification information and a authorization request for a designated layer of content of digital contents from a terminal;
generating an authorization certificate based on the identification information and a key of the designated layer of content of the digital contents; and
sending the designated layer of content of the digital contents and the authorization certificate to the terminal.

10. The digital content authorization method according to claim 9, wherein the process of generating an authorization certificate based on the identification information and the key of the designated layer of content of the digital contents comprising:
encrypting the key based on the identification information, and generating the authorization certificate based on the encrypted key and an identifier of the designated layer of digital contents.

11. The digital content authorization method according to claim 9, further comprising: by the server,
determining whether the terminal has obtained the authorization for the designated layer of content based on the identification information and the identifier of the designated layer of content; and
if the terminal has obtained the authorization for the designated layer of content, reminding the terminal to obtain authorization for other layers of contents of the digital contents.

12. The digital content authorization method according to claim 10, further comprising: by the server,
determining whether the terminal has obtained the authorization for the designated layer of content based on the identification information and the identifier of the designated layer of content; and
if the terminal has obtained the authorization for the designated layer of content, reminding the terminal to obtain authorization for other layers of contents of the digital contents.
